(19) United States
(12) Patent Application Publication
(10) Pub. No.: US 2010/0110294 A1
(43) Pub. Date: May 6, 2010

(54) VIDEO DISPLAY DEVICE, VIDEO DISPLAY METHOD AND VIDEO SYSTEM

(76) Inventor: Kimihisa Oka, Ome-shi (JP)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/608,612

(22) Filed: Oct. 29, 2009

(30) Foreign Application Priority Data
Oct. 31, 2008 (JP) 2008-281802

(51) Int. Cl. H04N 5/445

(52) U.S. Cl. 348/564; 348/E05.099

(57) ABSTRACT

According to one embodiment, a video display device includes an HDMI interface which transfers video information and control commands to and from a video output device connected thereto. The video display device further includes a video display module having one or more display areas to display external video and/or internal video, and a notification module which notifies resolution information for the display areas to the video output device using the control commands when the video display module simultaneously displays multiple videos including the external video.

### CROSS-REFERENCE TO RELATED APPLICATIONS

This application is based upon and claims the benefit of priority from Japanese Patent Application No. 2008-281802, filed Oct. 31, 2008, the entire contents of which are incorporated herein by reference.

### BACKGROUND

1. Field

One embodiment of the present invention relates to a video display device, a video display method and a video system which are adapted to display one or more videos.

2. Description of the Related Art

Examples of known video display devices adapted to display one or more videos are a video and image output device disclosed in Jpn. Pat. Appln. KOKAI Publication No. 2006-13987 and a video display device and a multiscreen display method disclosed in Jpn. Pat. Appln. KOKAI Publication No. 2008-79077.

Jpn. Pat. Appln. KOKAI Publication No. 2006-13987 discloses a video and image output device which includes video output means, image signal output means for outputting an image to a specified image area, image display area notification means for determining the optimum image display area on the basis of a combination of a video type and a video resolution obtained from the video output means, the monitor resolution from an external monitor, and a user-specified resolution from a remote controller and outputting an image for the optimum image display area, and video and image combination means for combining a video signal and an image signal (see Abstract). This device determines a suitable screen resolution to cope with video signals having various resolutions, monitors of various resolutions, and user-specified monitor resolutions to (see paragraph 0015).

Jpn. Pat. Appln. KOKAI Publication No. 2008-79077 discloses a video display device capable of simultaneously displaying a television screen and a browser screen. In this device, the display area is split and display is made to conform to resolutions (see Abstract). The device is capable of browsing Web pages with a small amount of scrolling (see paragraph 0014).

The inventions disclosed in Jpn. Pat. Appln. KOKAI Publications Nos. 2006-13987 and 2008-79077 have a function of making multiscreen display according to resolutions, however, the display device side has no initiative in obtaining that function. In such a case, an operation of determining the display resolutions or the like can not be initiated on the display side until a certain action is made by the video output device.

The display device side is not expected to take the initiative in displaying one or more screens according to resolutions.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not limit the scope of the invention.

FIG. 1 is a block diagram illustrating an example of a system configuration including a video display device and video output devices according to an embodiment of the invention;

FIG. 2 is a flowchart illustrating an example of a processing in a video display method according to an embodiment of the invention;

FIG. 3 is an exemplary diagram for explaining an initial stage in which the HDMI connection between a video output device (PC) and the video display device (digital TV) is set up to send the PC screen to the TV side;

FIG. 4 is an exemplary diagram for explaining a stage in which display resolution information is sent from the video display device (digital TV) to the video output device (PC) using a control command (HDMI-CEC);

FIG. 5 is an exemplary diagram for explaining switching from single-screen display to dual-screen display (PC screen and broadcast screen);

FIG. 6 is an exemplary diagram illustrating how the PC screen from the video output device (PC) is displayed in the dual-screen display area of the video display device (digital TV);

FIG. 7 is an exemplary diagram for explaining a stage in which display resolution information is sent from the video display device (digital TV) to a video output device (digital video recorder) using a control command (HDMI-CEC); and

FIG. 8 is an exemplary diagram for explaining switching from single-screen display to dual-screen display (recorder screen and broadcast screen).

### DETAILED DESCRIPTION

Various embodiments of the invention will be described hereinafter with reference to the accompanying drawings.

According to one embodiment of the invention, the video display device comprises a digital interface which can transfer video information and control commands to and from a video output device connected thereto by cable or radio. The video display device further comprises a video display module having one or more display areas to display one or more videos (external video and/or internal video) including external video present in the video information sent via the digital interface from the video output device or internal video obtained without passing through the interface, and a notification module which notifies resolution information for the display areas to the video output device by the control command when the video display module simultaneously displays multiple videos including the external video.

When simultaneously displaying multiple videos, the video display device sends the control command to the video output device, thus allowing the video display device to take the initiative in determining the display resolution.

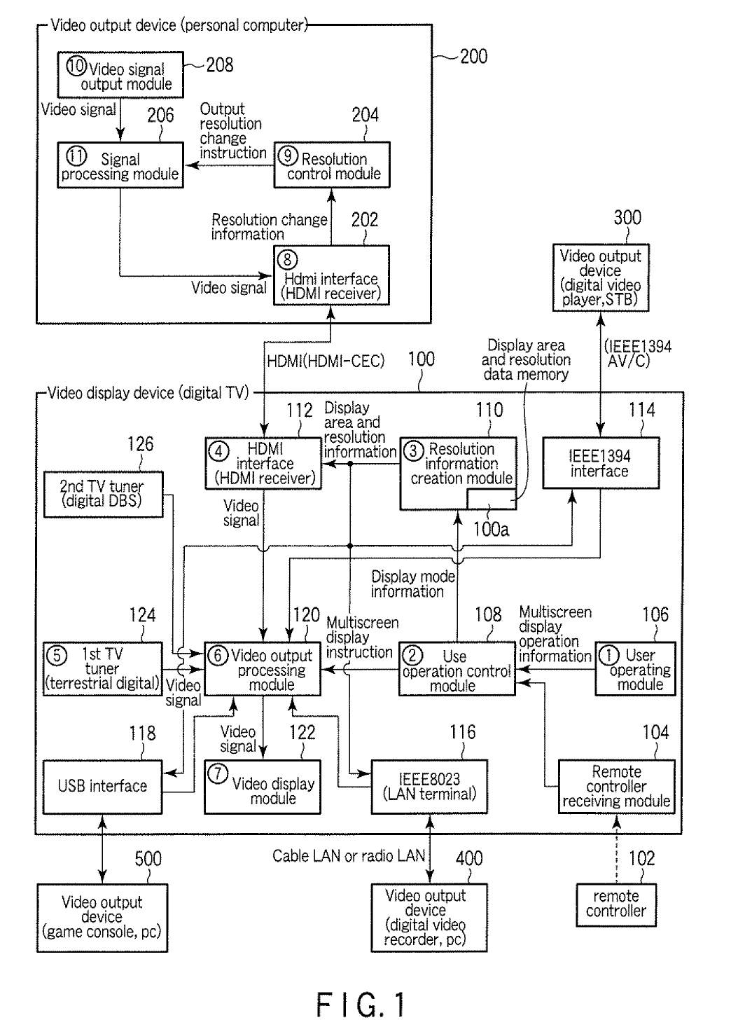

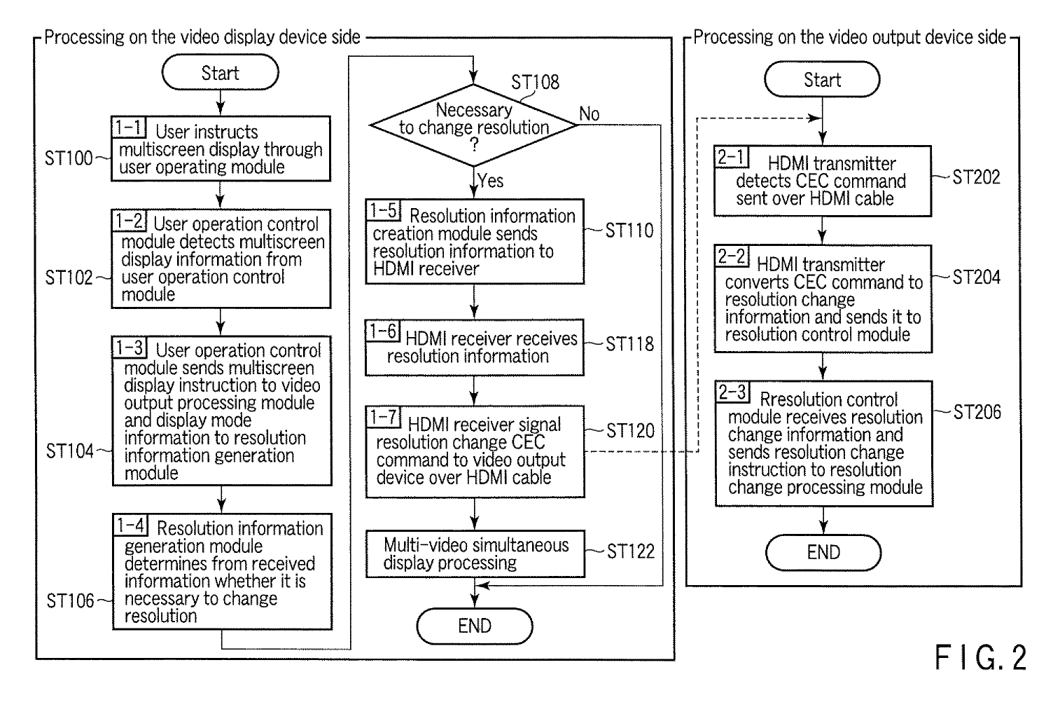

Various embodiments of the invention will be described hereinafter. FIG. 1 illustrates an example of a system configuration including a video display device (digital TV or the like) and video output devices (a personal computer and so on) according to an embodiment of the invention. FIG. 2 is a flowchart illustrating an example of a processing in the system configuration of FIG. 1.

In the example of FIGS. 1 and 2, a High-Definition Multimedia Interface (HDMI) is used as the digital interface which interconnects the video display device 100 and a video output device 200. In transmission lines of HDMI standards, a line capable of bidirectionally transmitting control data, which is referred to as a Consumer Electronics Control (CEC) line, is prepared separately from a video data transmission line. CEC commands can be used for control between source equipment (information sender) and sink equipment (information receiver) which are interconnected by an HDMI standard transmission line. The use of the CEC line allows control of equipment (HDMI-CEC compatible equipment) at the other end of the line.

In the configuration of FIG. 1, a user operation to the video display device 100 is input to a remote controller 102. The user operation input to the remote controller 102 is received by a remote controller receiving module 104. The user operation to the video display device 100 can also be input through a user operating module 106 set on the control panel (not shown) of the video display device. When a command is given by the user to go into the multiscreen display mode through the remote controller 102 or the operating module 106, multiscreen display operating information is sent from the receiving module 104 or the operating module 106 to a user operation control module 108 to enter the multiscreen display procedure (ST100 in FIG. 2).

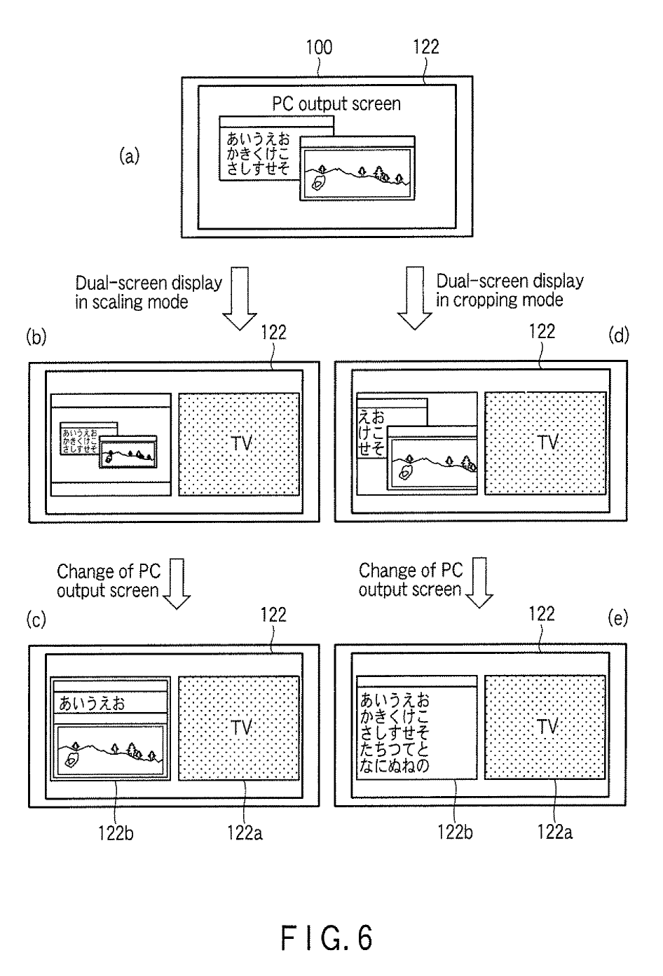

Upon receipt of the multiscreen display operating information (ST102), the user operation control module 108 sends a multiscreen display instruction to a video output processing module 120 and display mode information to a resolution information generation module 110 (ST104). Upon receipt of the display mode information, the resolution information generation module 110 determines from the received information whether it is necessary to change the resolution (ST106). A specific criterion of this determination will be described later with reference to FIG. 6. The resolution information generation module 110 has a memory 100a to store display area data including information about the size of each display area and resolution data including information about a resolution acceptable to the device 100.

When it is necessary to change the resolution (YES in ST10), the resolution information generation module 110 sends resolution information (information on display resolution) to an HDMI receiver 112 (ST110). Information about the sizes, positions and number of display areas may also be sent together with the resolution information. Upon receipt of the resolution information, the HDMI receiver 112 outputs a CEC command to inform the video output device 200 of changes to the resolution on an HDMI cable (ST120). The cable corresponds to a double-headed arrow line between the HDMI receiver 112 and an HDMI transmitter 202 in FIG. 1.

As a result of the CEC command being output from the video display device 100 (namely, owing to the initiative of the video display device side), processing on the video output device side is initiated. That is, the HDMI transmitter 202 detects the HDMI-CEC command sent over the HDMI cable from the HDMI receiver 112 (ST202). The HDMI transmitter 202 then converts the detected CEC command into resolution change information and sends it to a resolution control module 204 (ST204). Upon receiving the resolution change information, the resolution control module 204 sends a resolution change instruction corresponding to the received resolution change information to a signal processing module 206 adapted to perform resolution change processing and so on (ST206).

The signal processing module 206 subjects a video signal from a video output module 208 to signal processing, such as changing of the resolution. The resulting video signal is sent from the HDMI transmitter 202 over the HDMI cable to the HDMI receiver 112. The HDMI receiver 112 receives the video signal from the HDMI transmitter 202 and output it to the video signal processing module 120.

On the one hand, a first TV tuner 124 receives a terrestrial digital broadcast wave and outputs the received terrestrial broadcast video signal to the video output processing module 120. A second TV tuner 126 receives a digital broadcast signal from a direct broadcast satellite (DBS) and outputs the received digital DES broadcast video signal to the video output processing module 120.

On the other hand, a video signal from a video output device (such as a digital video player or a set-top box [STB]) 300 is optionally sent via an IEEE 1394 interface 114 to the video output processing module 120. In addition, a video signal from a video output device (such as a digital video recorder or a PC) 400 with which the video display device 100 is networked (by cable or radio) is also optionally sent via an IEEE 802.3 LAN terminal 116 to the video output processing module 120. Furthermore, a video signal from a video output device (such as a computer game console or a PC) 500 is also optionally sent via a USB interface 118 to the video output processing module 120. Moreover, though not shown, an image or a video signal from a memory card (IC card) loaded into a memory slot is also optionally sent to the video output processing module 120.

The video output processing module 120 performs a process of distributing external video contained in a video signal from the video output device 200 and internal video contained in a video signal from the first TV tuner 124 and/or the second TV tuner 124 to multiple display areas each of a given size. Thereby, a video signal is produced which allows each of the external and internal videos to be simultaneously displayed in a respective one of the display areas at given resolutions (ST122). The resulting video signal is sent to a video display module (such as a flat panel display or a projector) 122.

In the above example, the external video which is one of the simultaneously displayed multiple videos is a video supplied from the video output device 200 via the HDMI interface. However, this is merely exemplary. A video supplied from the video output device 300 via the IEEE 1394 interface may be used as the external video. In this case, the IEEE 1394 AVC/C command can be used in place of the HDMI-CEC command. Specifically, information exchange can be made between the video display device 100 and the video output device 300 utilizing the Vendor Dependent command that meets AV/C command standards and response data to the command.

Furthermore, IEEE 802.3 and USB can be used for connection to video output devices in addition to HDMI and IEEE 1394. A video from the video output device 400 connected via the IEEE 802.3 interface or the video output device 300 connected via the USB interface may be used as an external video to be displayed simultaneously with an internal video. In addition, images from a memory card (IC card) inserted in the card slot not shown can be used as an external video.

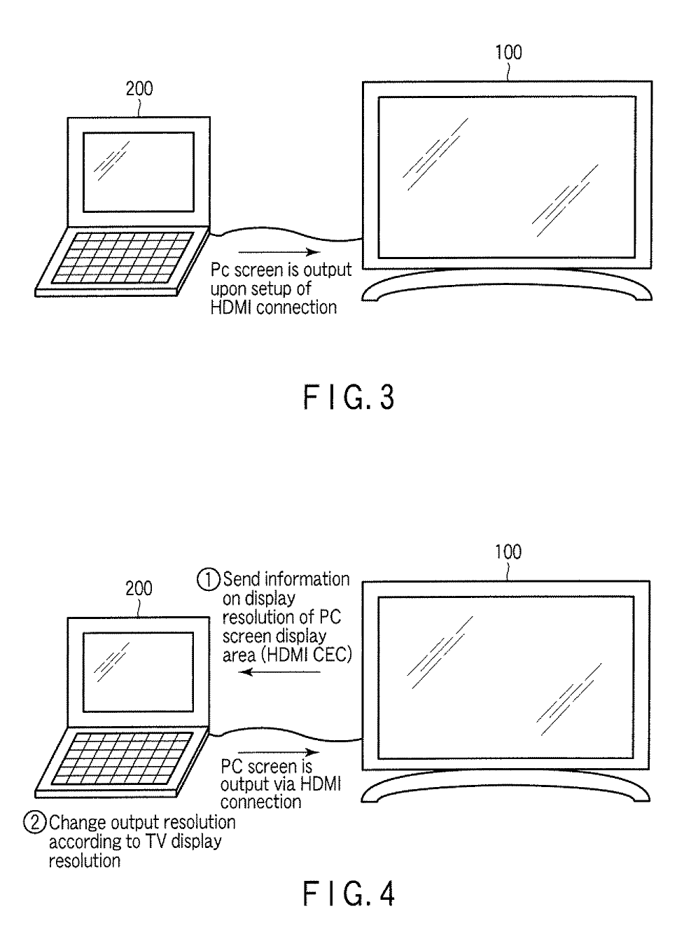

FIG. 3 is an exemplary diagram for explaining an initial stage in which the HDMI connection is set up between the video output device (personal computer [PC]) 200 and the video display device (digital TV) 100 and the PC screen is sent to the TV side. At this stage, the output video from the PC 200 can be displayed in full (single-screen display mode) on the TV 100 (see (a) of FIG. 6).

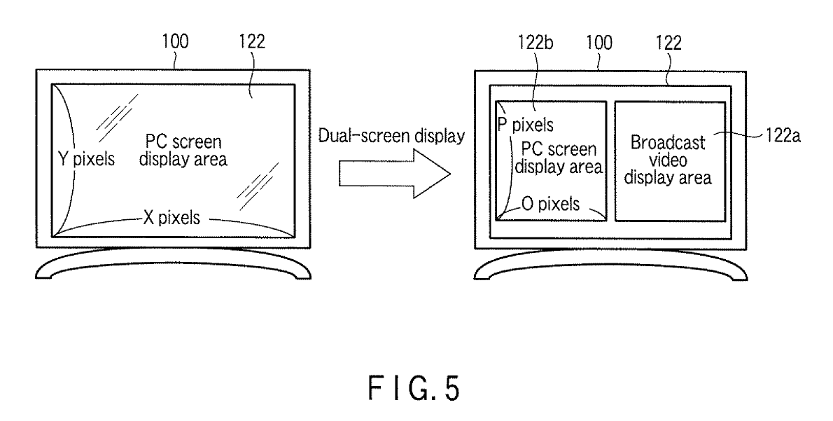

FIG. 4 is an exemplary diagram for explaining a stage in which display resolution information is sent from the video display device (TV) 100 to the video output device (PC) 200 through a control command (HDMI-CFC). FIG. 5 is an exemplary diagram for explaining switching from single-screen display to dual-screen display in the video display device 100. Furthermore, FIG. 6 is an exemplary diagram illustrating how the PC screen from the video output device 200 is displayed in the dual-screen display areas of the video display device 100.

When the user switches the display mode of the TV 100 to the dual-screen display mode to watch TV in addition to the PC screen, the display area of the video display module 122 of the TV 100 is separated into a broadcast video display area 122a and a PC screen display area 122b as shown in FIG. 5. It is assumed here that the display sizes, display locations and display resolutions of the respective display areas 122a and 122b have been preset in the memory 100a. At this point, the display size is changed from a large size of X×Y pixels to a small size of O×P pixels. The user will see the PC screen in the small display area 122b. As a result of the display size being reduced, there will arise disadvantages that the PC screen becomes difficult to see ((b) of FIG. 6) and a portion of the image to be displayed in the PC screen is cropped ((d) of FIG. 6). At this point, however, the PC is not concerned with the disadvantage. If, therefore, nothing is done on the TV side, the difficulty of seeing the PC screen will be left.

Accordingly, the TV 100 sends information concerning the display resolution of the PC screen display area 122b (including information that the PC screen display area has been changed to O×P pixels) to the PC 200 using the HDMI-CEC command as shown in FIG. 4 (see ST120 in FIG. 2). Upon receipt of the information, the PC 200 changes the output resolution according to the current display resolution of the TV 100 so that the video output to the TV side just fits in the display area 122b of O×P pixels (in FIG. 1, the control module 204 instructs the processing module 206 to change the output resolution).

(a), (b), and (d) of FIG. 6 represent conventional processing carried out when the TV 100 goes into the dual-screen display mode. Here, examples of the conventional processing are scaling and cropping. In the conventional scaling mode, the PC output screen is displayed in its entirety. However, the display screen is scaled down, resulting in a problem that TV viewers have difficulty identifying characters and videos. In the conventional cropping mode, a portion of the PC output screen is cropped, leading to a problem that the PC operability is impeded or all the information on the PC output screen cannot be viewed.

The above problems can be solved in the following way. That is, resolution information for the PC screen display area 122b in FIG. 5 is sent from the TV 100 to the PC 200. The PC 200 detects the resolution information and sets small the screen size (resolution) of the video output to the TV 100 without the user having to operate the PC. When the output resolution (screen size) from the PC 200 is moderately small and the video is simply displayed in the display area as it is, the TV 100 needs not to perform scaling or cropping. In that case, it becomes possible to prevent characters from becoming difficult to view due to their reduction in size or the PC operability from being impeded by a portion of display information being cropped.

(c) and (e) of FIG. 6 show exemplary PC output screens in the dual-screen display mode according to the embodiment of the invention. (c) and (e) of FIG. 6 show the results of internal processing by the PC 200 which has received the resolution information. (c) of FIG. 6 shows a state in which windows on the operating system (OS) of the PC 200 are displayed so that they overlap each other. In this example, the PC screen size (display resolution) is changed and moreover the windows (windows in (a), (b) and (c) of FIG. 6) which were arranged relatively apart from each other before the screen size is changed have their locations and sizes changed so that they fit into the screen which has been changed in size. In the example of (e) of FIG. 6, on the other hand, the PC screen size is changed and moreover a window (the character window in this example) on the OS is maximized to automatically conform to the screen size.

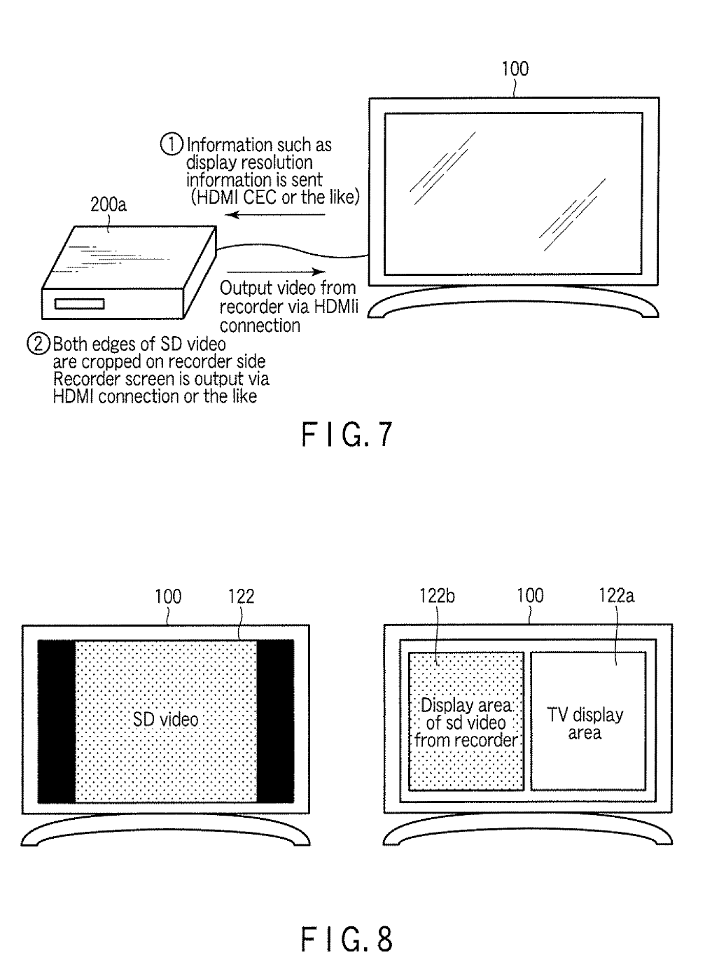

FIGS. 7 and 8 show an example different from the one of FIGS. 4 and 5. In the example of FIG. 4, a notebook personal computer is used as the video output device 200. In FIG. 7, a digital video recorder (for example, a DVD recorder) which outputs a video of standard resolution (SD) is used as a video output device 200a. The recorder 200a also has the same arrangement as the video output device 200 has in FIG. 1. Upon receipt from the video display device (digital TV) 100 of display resolution information (including information about the ratio of the width of the display area to the height) via, for example, the HDMI-CEC command, the recorder 200a carries out a process of cropping (cutting off) the right and left edges of the SD video in the signal processing module 206. The cropping is performed to conform to the ratio of the width of an SD video display area 122b to the height.

For example, suppose that the ratio of the width of the original SD video of the height (aspect ratio) is 4:3 (or 640 by 480 dots in size) and the aspect ratio of the SD video display area 122b is 3:3 (or 480 by 480 dots). In this case, with the size of the original SD video in the vertical direction as 3, portions corresponding in size to a half at each of the right and left edges of the video are cropped. In other words, with the size of the original SD video in the vertical direction as 480 dots, 80 dots are cut out at each of the right and left edges of the video.

On the left side of FIG. 8, the original SD video of an aspect ratio of 4:3 is shown single-screen displayed on the display module 122 which is 16:9 in aspect ratio. When a video of 4:3 is fitted into a screen of 16:9 with their vertical sizes matched with each other, blank areas are produced at the left and right of the screen. When the display screen 122 is switched into the dual-screen display mode, the aspect ratio of the SD video display area 122b becomes 3:3 as shown at the right of FIG. 8, resulting in a reduction in the width of the display area. Thus, the SD video having its right and left edges slightly cut out is displayed in the narrowed display area 122b. With a video that mainly contains pictures as opposed to characters, it is possible to sufficiently enjoy video content in practical use even if its right and left edges have been slightly cropped.

### (Modifications)

The video output device may be a digital video recorder/player, an external tuner (STB), a network interface, or the like. The connection between the video display device and the video output device may be made by an arbitrary method, such as by cable or by radio. Video signals and control signals, such as resolution information, may be transmitted using separate signal lines or separate radio-frequency bands.

The resolution information can be sent from the video display device 100 in the form of data of given structure or a command specified in advance. The device may have a function of stopping the multiscreen display mode when the user does not desire it. In this case, the stopping function may be provided in either the video display device or the video output device.

The processing on a video signal in the video output device which has received resolution information includes arbitrary processing, such as scaling, cropping, etc. For example, in addition to output resolution changing, cropping and scaling, the processing includes N-times speed reproduction interpolated image creation processing (N is usually in the range of 2 to 32), very-high-resolution processing for up-conversion of low-resolution standard-definition (SD) images to high-resolution high-definition (HD) images, down-conversion from HD images to SD images, conversion of color video to monochrome video, and processing of cutting out a portion of an image. The video signal transmission rate between the output device and the display device may be changed in converting SD images to HD images or vice versa. The high transmission rate adapted for HD images is not needed in outputting SD images.

### Summary of the Embodiment

When displaying one or more videos, the video display device outputs display area resolution information to the video output device in an arbitrary method.

The video output device performs a corresponding process on a video on the basis of the input resolution information and outputs the resulting video to the video display device.

The information about the resolution of the video display device can be change dynamically and is output to the video output device.

Even after the video display device and the video output device have been connected together, the resolution of a video output from the video output device to the video display device changes according to the conditions of the video display device under the leadership of the video display device side. Thereby, the video display device is allowed to display a video of resolution suitable for the intention of the user.

### Advantages of the Embodiment

When simultaneously displaying two or more videos, the video display device notifies via its notification module resolution information on display areas to the video output device, thus allowing the video display device to take the initiative in determining the display resolutions.

### Correspondence between the Embodiment and Aspects of the Invention

A video display device (a digital TV, PC with video display function, mobile phone with video display function, projector, or the like) comprises a digital interface (112 to 118: HDMI, IEEE 1394, or the like) connectable to a video output device (by cable or radio) and configured to transfer video information (AV information) and control commands (HDMI-CEC and AV/C commands, etc.) to and from the video output device, a video display module (122) having one or more display areas to display one or more videos (external video and/or internal video) including an external video (web images from a PC and so on) present in the video information (AV information) or an internal video (broadcast program video from a built-in tuner of a TV) obtained without intervention of the digital interface, and a notification module (110 to 118) configured to notifies resolution information for the display areas to the video output device using the control commands when the video display module simultaneously displays multiple videos including the external video (for example, external video from the PC and internal video from the TV built-in tuner).

(2) The video display device of (1), wherein the notification module includes a mode for notifying the resolution information notification mode to the video output device, and the notification module notifies the resolution information to the video output device (without waiting for an inquiry from the video output device), upon entering the mode (for example, by a user's operation on a remote controller).

(3) The video display device of (1), wherein the notification module is configured to notify the resolution information to the video output device when the logical connection between the video output device and the video display device is set up through the digital interface (by default without waiting for an inquiry from the video output device).

(4) The video display device of (1), wherein the video display module has multiple display resolutions (SD resolution, HD resolution, etc.), and the notification module is configured to notify the resolution information to the video output device when the display resolution is changed.

(5) The video display device of (1), wherein the video display module has one or more display areas of fixed or variable size, and the notification module is configured to notify to the video output device current size information about a display area which displays the external video (the display size of the current external video).

(6) A video system (FIG. 1) including a video display device (100: a digital TV or the like) having a first digital interface (112: HDMI or the like) configured to transfer video information (AV information) and control commands (HDMI-CEC and so on), and a video output device (200; a PC or the like) having a second digital interface (202: HDMI or the like) configured to transfer video information (AV information) and control commands (HDMI-CEC and so on) and connected to the first digital interface, the video display device (100) comprising: a video display module (122) having one or mode display areas (122a, 122b) to display one or more videos including external video present in the video information sent from the video output device (200) via the first and second digital interfaces (112, 202) or internal video obtained without intervention of the first and second digital interfaces; and a notification module (110 to 112) configured to notify size and resolution information for the display areas to the video output device by the control command, and the video output device (200) comprising: a module (208) configured to perform a predetermined processing (output resolution change processing, N-times speed reproduction interpolated pixel creation processing, extra resolution processing for up-conversion of low-resolution SD images to high-resolution HD images, etc.) of the external video to be sent to the video display device (100) through the first and second interfaces (112, 202) on the basis of the size and resolution information notified by the control command and cause the processed external video to be displayed in the display area of the video display device.

(7) The video system of (6), wherein when the external video and the internal video are simultaneously displayed side by side and the display size of the external video is relatively too small ((6) of FIG. 6), the display size (pixel-based size) of the external video is changed to be relatively large in comparison between the display areas. When multiple screens are simultaneously displayed on the display module 122, the above processing may be performed for one screen.

(8) The video system of (6), wherein, when the external video and the internal video are simultaneously displayed side by side and a portion of the external video is missing away, the partial missing of the external video is removed. When multiple screens are simultaneously displayed on the display module 122, the above processing may be performed for one screen.

(9) The video system of (6), wherein, when the external video and the internal video are simultaneously displayed side by side and the external video (web images or the like) contains characters, the display size and/or resolution of the external video are determined to make the characters readable in the viewing position for the internal video (TV programs or the like). For example, it is assumed that the height of the display screen is H and a person with an eyesight of 0.5 watches TV in the viewing position 5H apart from the display screen in the direction normal to the display screen surface. On that assumption, such resolutions of external video as allow characters to be read in the viewing position are determined experimentally for some display sizes using video samples containing characters of a specific font size and two or more test subjects. The resultant experimental data are written to the memory 100a.

(10) A video display method which uses a video display device (100) having a digital interface (112) configured to transfer video information and control commands to and from a video output device (200), the method comprising: displaying one or more videos including external video present in the video information sent from the video output device through the digital interface or internal video obtained without intervention of the digital interface; and notifying resolution information for display areas from the video display device to the video output device by using the control commands (ST120) when multiple videos including the external video (say, external video from a PC and internal video from the TV built-in tuner) are simultaneously displayed.

(11) A video device comprising: a video display module (120 to 122) having one or more display areas to display one or more videos including video sent from a video output device (reproduced video or the like) and video sent from a broadcast receiver; an instruction module (102 to 108) for instructing the video display module (120 to 122) to perform multiscreen display when the video display module simultaneously displaying multiple videos (for example, reproduced video and broadcast program video); and a notification module for notifying resolution information for the display areas to the video output device when the video display module simultaneously displays the multiple videos as instructed by the instruction module.

The invention is not limited to the above-described embodiments. At the stage of practice of the invention, the invention can be embodied in various modified forms without departing from the scope thereof. The embodiments may be implemented in combination as much as possible, in which case the combined advantages will be obtained. Furthermore, the above-described embodiments contain various inventions and various inventions can be extracted from appropriate combinations of the disclosed constituent elements. For example, some of the constituent elements shown in the embodiments may be removed provided that the problems described in the section of “Problems to be Solved by the Invention” can be solved and the advantages described in the section of “Utility of the Invention” can be obtained. The arrangements which have some of the constituent elements removed can be extracted as inventions.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various embodiments, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A video display device comprising:
a digital interface connectable to a video output device and configured to transfer video information and control commands to and from the connected video output device;
a video display module having one or more display areas to display one or more videos including an external video present in the video information sent from the video output device or an internal video obtained without intervention of the digital interface; and
a notification module configured to notify resolution information for the display areas to the video output device using the control commands when the video display module simultaneously displays multiple videos including the external video.

2. The video display device of claim 1, wherein the notification module includes a mode for notifying the resolution information to the video output device, and the notification module is configured to notify the resolution information to the video output device upon entering the mode.

3. The video display device of claim 1, wherein the notification module is configured to notify the resolution information to the video output device when the logical connection between the video output device and the video display device is set up through the digital interface.

4. The video display device of claim 1, wherein the video display module has multiple display resolutions, and the notification module is configured to notify the resolution information to the video output device when the display resolution is changed.

5. The video display device of claim 1, wherein the video display module has one or more display areas of fixed or variable size, and the notification module is configured to notify to the video output device current size information about a display area which displays the external video.

6. A video system including a video display device having a first digital interface configured to transfer video information and control commands, and a video output device having a second digital interface configured to transfer video information and control commands and connected to the first digital interface,
the video display device comprising: video display module having one or mode display areas to display one or more videos including external video present in the video information sent from the video output device via the first and second digital interfaces or internal video obtained without intervention of the first and second digital interfaces; and a notification module configured to notify size and resolution information for the display areas to the video output device by the control command when the video display device simultaneously displays multiple videos including the external video, and
the video output device comprising a module configured to perform a predetermined processing of the external video to be sent to the video display device through the first and second interfaces on the basis of the size and resolution information notified by the control command and cause the processed external video to be displayed in the display area of the video display device.

7. The video system of claim 6, wherein, when the external video and the internal video are simultaneously displayed side by side and the display size of the external video is relatively too small, the display size of the external video is changed to be relatively large in comparison between the display areas.

8. The video system of claim 6, wherein, when the external video and the internal video are simultaneously displayed side by side and a portion of the external video is missing, the partial missing of the external video is removed.

9. The video system of claim 6, wherein, when the external video and the internal video are simultaneously displayed side by side and the external video contains characters, the display size and/or resolution of the external video are determined to make the characters readable in the viewing position for the internal video.

10. A video display method using a video display device having a digital interface configured to transfer video information and control commands to and from a video output device, the method comprising:
displaying one or more videos including external video present in the video information sent from the video output device through the digital interface or internal video obtained without intervention of the digital interface; and
notifying resolution information for display areas from the video display device to the video output device by using the control commands when multiple videos including the external video are simultaneously displayed.

11. A video device comprising:
a video display module having one or more display areas to display one or more videos including video sent from a video output device and video sent from a broadcast receiver;
an instruction module configured to instruct the video display module to perform multiscreen display when the video display module simultaneously displays multiple videos; and
a notification module configured to notify resolution information for the display areas to the video output device when the video display module simultaneously displays the multiple videos as instructed by the instruction module.
